(19) United States
(12) Patent Application Publication
(10) Pub. No.: US 2011/0063293 A1
(43) Pub. Date: Mar. 17, 2011

(54) IMAGE PROCESSOR

(75) Inventor: Yoshihisa KOHARA, Kanagawa-ken (JP)

(73) Assignee: Kabushiki Kaisha Toshiba, Tokyo (JP)

(21) Appl. No.: 12/875,458

(22) Filed: Sep. 3, 2010

(30) Foreign Application Priority Data
Sep. 15, 2009 (JP) 2009-213275

(51) Int. Cl. G06T 15/40; G06T 15/00

(52) U.S. Cl. 345/421; 345/419

(57) ABSTRACT

According to one embodiment, an image processor is disclosed. The image processor can include a material image drawing portion drawing a material image, the material image is a material for a 3D display, a material image memory portion storing data of the material image drawn by the material image drawing portion, and an image generator generating image data for the 3D display on a basis of the data of the material image read from the material image memory portion, depth information configured to the material image, and viewpoint position information preliminary configured, and outputting the image data to a display portion.

### CROSS REFERENCE TO RELATED APPLICATION

This application is based upon and claims the benefit of priority from prior Japanese Patent Application No. 2009-213275, filed on Sep. 15, 2009, the entire contents of which are incorporated herein by reference.

### FIELD

Exemplary embodiments described herein relate to an image processor.

### BACKGROUND

A 3D-display for displaying three dimensional vision provides stereoscopic vision to observers by displaying an image having disparity difference for both eyes.

The 3D-display with multi viewpoints, for example, providing stereoscopic image effect for the observers in a plural positions is proposed as the 3D-display.

A method for drawing and retaining binocular images corresponding to a number of the viewpoint positions of the observers is adopted in the 3D-display.

Therefore, image processing load, memory consumption amount, transaction of system bus or the like are increased with increasing a number of the viewpoint positions corresponded to observers, so that a problem in which hardware constitution load is enlarged is generated.

### BRIEF DESCRIPTION OF THE DRAWINGS

FIG. 1 is a block diagram showing a structure of a display system including an image processor according to an embodiment;

FIG. 2 is a block diagram showing a structure of an image generator according to the embodiment;

FIG. 3 is a conceptual diagram showing data and depth information of a material image retained in memories;

FIG. 4 is an explanation view showing generation of a disparity by a disparity generator;

FIG. 5 is an explanation view showing compositing a binocular image by an image compositor;

FIG. 6 is a flow chart explaining an operation order of the image processor.

### DETAILED DESCRIPTION

According to one embodiment, an image processor is disclosed. The image processor can include a material image drawing portion drawing a material image, the material image is a material for a 3D display, a material image memory portion storing data of the material image drawn by the material image drawing portion, and an image generator generating image data for the 3D display on a basis of the data of the material image read from the material image memory portion, depth information configured to the material image, and viewpoint position information preliminary configured, and outputting the image data to a display portion.

An embodiment of the present invention will be described below in detail with reference to the attached drawings mentioned above. Throughout the attached drawings, similar or same reference numerals show similar, equivalent or same components.

### Embodiment

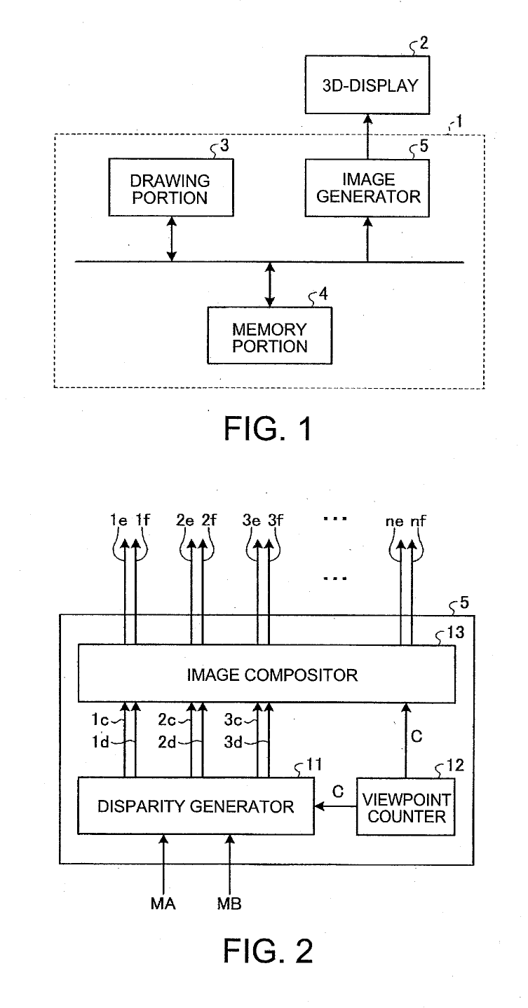

FIG. 1 is a block diagram showing a structure of a display system including an image processor 1 according to an embodiment. The display system includes the image processor 1 and a 3D-display 2. The image processor 1 includes a drawing portion 3, a memory portion 4 and an image generator 5. The image processor 1 generates image data for 3D display and output the image data to the 3D-display 2. The 3D-display 2 acts as a display portion for 3D display.

The drawing portion 3 acts as a material image drawing portion which draws a material image being material for 3D display. The memory portion 4 acts as a material image memory portion which stores both data of the material image (called material image data hereafter) drawn by the drawing portion 3 and depth information set to the material image. The material image data are color data of each pixel constituting the material image, for example, R, G, and B signal values of three primary colors. The depth information is position information of images configured on a depth direction in a 3D direction, for example, is configured by users. The image generator 5 acts as a 3D image generator which generates the image data for 3D display on a basis of the material image data read out from the memory portion 4, depth information and viewpoint position information. The viewpoint position information is the position information of the views which have a capability of stereoscopic view of the 3D display. Position and number of the viewpoint position information can be preliminary configured by a specification of the 3D-display 2.

FIG. 2 is a block diagram showing a structure of an image generator. The image generator 5 includes a disparity generator 11, a viewpoint position counter 12 and an image compositor 13. The image generator 5 includes a disparity generator 11, a viewpoint position counter 12 and an image compositor 13. The disparity generator 11 acts as a disparity portion generating a binocular image of each viewpoint position in corresponding the depth information and the viewpoint position information. The binocular image means including both a left eye image and a right eye image. The disparity means is an angle difference of a sight line vector when both the right and the left eyes look a point. The viewpoint position counter 12 outputs a count value C representing the viewpoint position as viewpoint position information. The image compositor 13 composites left eye images, each left eye image corresponds to each material image, and composites right eye images, each right eye image corresponds to each material image, so as to generate the image data for the 3D display.

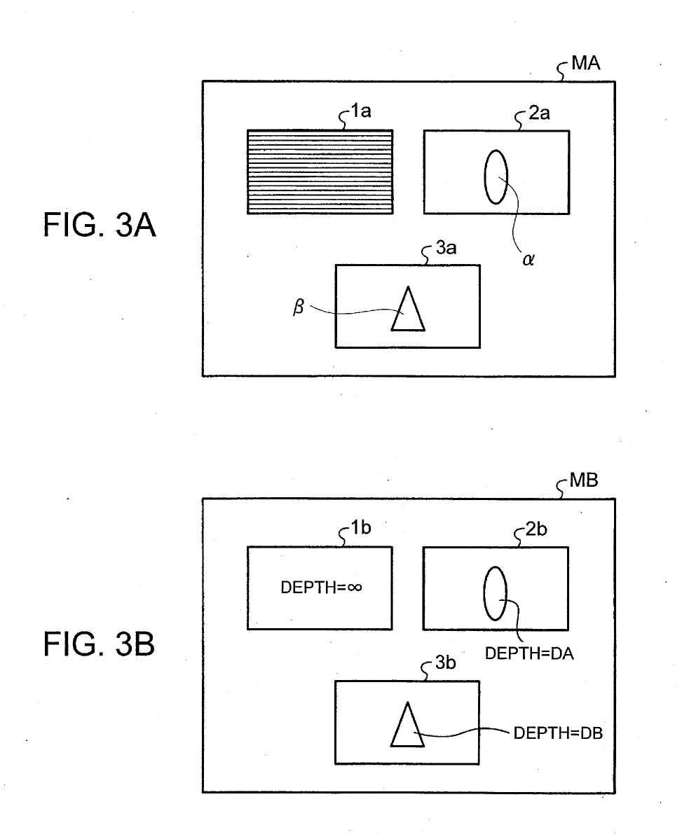

Next, operation of the image processor 1 is explained. FIG. 3 is a conceptual diagram showing data and depth information of a material image retained in memories. In FIGS. 3A and 3B, a memory area MA stored the material image data and a memory area MB stored the depth information are illustrated, respectively. by using the drawing portion 3, for example, a material image 1a with infinity in the depth as a background, a material image 2a with a depth DA which is set to be 0<DA<infinity, the material image 2a being a elliptical body which is called an object α hereafter and a material image 3a with a depth DB which is set to be 0<DB<infinity, material image 3a being an isosceles triangle body which is called an object β hereafter.

Each of data of the material images la, 2a, 3a is stored in each frame buffer in the memory area MA.

Each of data of the depth information 1b with the depth of infinity, the depth information 2b with the depth being DA and depth information 3b with the depth being DB corresponding to material images 1a, 2a and 3a are stored in each depth buffer of the memory area MB.

The image generator 5 as shown in FIG. 2 reads the data of each frame buffer stored in the memory area MA and reads the data of each depth buffer stored in the memory area MB one line by one line to the parallel direction, respectively. The data read in the image generator 5 is input in the disparity generator 11. Further, the count value C from the viewpoint position counter 12 is input in the disparity generator 11. Further, the depth information is not restricted to store in the memory portion 4. For example, the depth information may be configured as a fixed value of each plane to the image generator 5.

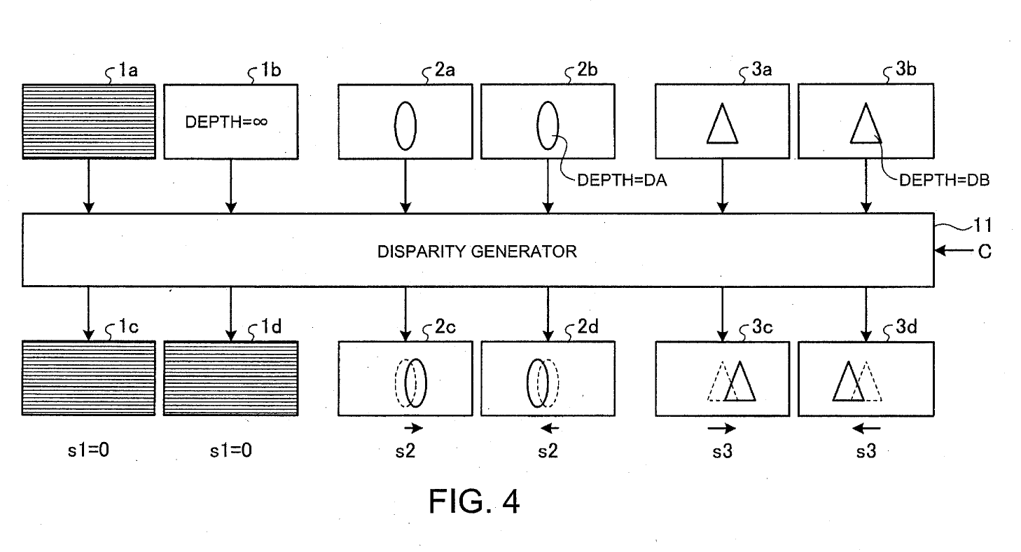

FIG. 4 is an explanation view showing generation of a disparity by a disparity generator 11. The binocular image is generated corresponding to the data of the depth buffer read from the memory area MB and the count value C generated in the disparity generator 11 on the basis of the data of each frame buffer read from the memory area MA.

The disparity generator 11 generates the left eye image 1c and the right eye image 1d in the background from the data of the material image 1a and the depth information 1b. As the depth information 1b is infinity, a disparity shift amount s1 between the images for both eyes 1c, 1d are set to be zero. The disparity generator 11 generates an image for the left eye 2c and an image for the right eye 2d. A disparity shift amount s2 between the image for the left eye 2c and the image for the right eye 2d of the object β is calculated corresponding to the depth information 2b and the viewpoint position information input as the count value C. The image for the left eye 2c is generated by shifting the object α to the right direction horizontally to the material image 2a as the disparity shift amount s2. The image for the right eye 2d is generated by shifting the object α to the left direction horizontally to the material image 2a as the disparity shift amount s2.

The disparity generator 11 generates an image for the left eye 3c and an image for the right eye 3d of the object β from data of the material image 3a and the depth information 3b. A disparity shift amount s3 between the images for the left eye 3c and the right eye 3d is calculated corresponding to the depth information 3b and the viewpoint position information input as the count value C. The image for the left eye 3c of the object β is generated by shifting the object β to the right direction horizontally to the material image 3a as the disparity shift amount s3. The image for the right eye 3d is generated by shifting the object β to the left direction horizontally to the material image 3a as the disparity shift amount s3. In General, as the disparity becomes larger when the position of the body viewed from the viewpoint is nearer, a relationship between s2<s3 is established between the disparity shift amount s2 and the disparity shift amount s3.

The disparity generator 11 generates the binocular images 1c, 1d for the background, the binocular images 2c, 2d of the object α and the binocular images 3c, 3d of the object β, when each count value C is input. The shifts of the objects α, β in generating the binocular images 2c, 2d, 3c, 3d to the material images 2a, 2b are performed by changing the relationship between the coordinate as a standard and the image corresponding to the disparity shift amount s2, s3.

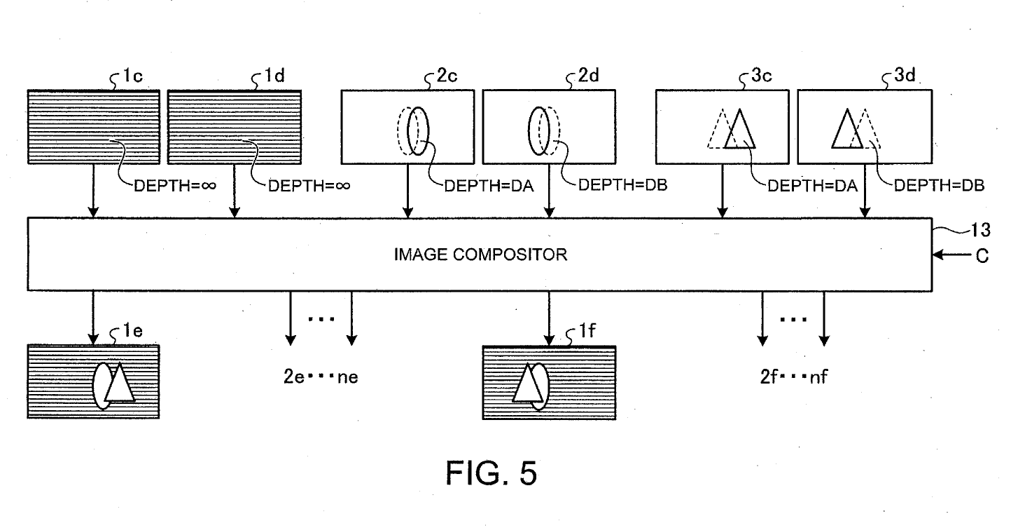

FIG. 5 is an explanation view showing compositing the binocular image by an image compositor. For example, viewpoints 1-n are configured as the view point position information where each of the viewpoints 1-n is set to be at a different position. The image compositor 13 generates an image for the left eye 1e to the viewpoint 1 by compositing the left eye image 1c of the object α in the background, the left eye image 2c of the object α and the left eye image 3c of the object R on the viewpoint 1 which is input as the viewpoint position information as the count value C. Further, the image compositor 13 generates an image for the right eye if to the viewpoint 1 by compositing the right eye image 1d of the object α in the background, the right eye image 2d of the object α and the right eye image 3d of the object β on the viewpoint 1. The image compositor 13 composites binocular images 1e, 1f by a compositing treatment to interpose the object β, the object α, and the background from the front side to the back side corresponding to the depth information 1b, 2b, 3b.

Hidden surface removal treatment which erases a region not shown from a viewpoint blanked by another body or a face, for example, is adopted in compositing images by the image compositor 13. The image compositor 13 may adopt a blend which translucently composites a plural images by using β value. The image compositor 13 composites left eye images 2e-ne and right eye images 2f-nf on the viewpoints 2-n as the same as the viewpoint 1. In such a manner, the image compositor 13 generates data of binocular images 1e-ne and 1f-nf in each viewpoint position as image data for 3D display.

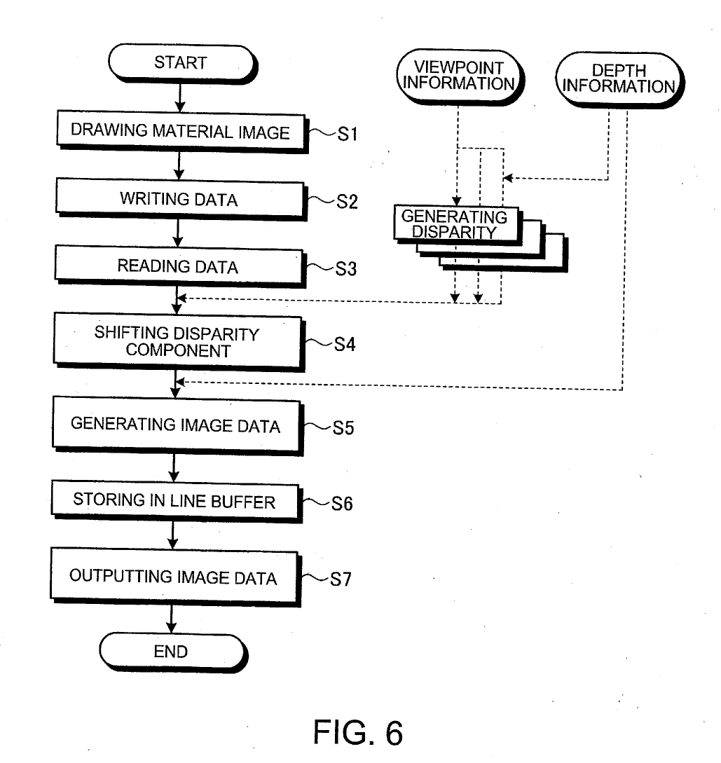

FIG. 6 is a flow chart explaining an action order of the image processor. The material image is drawn by the drawing portion 3 in step S1 to read the material image data into the memory 4 in step S2. A start of the 3D display is instructed, for example, by operating a switch or the like to read out the material image data and depth information to the image generator 5 in step S3.

Next, a disparity component corresponding to a relation between the coordinate and the image is shifted in step S4 to generate binocular image in the disparity generator 11. The disparity generates on each viewpoint by calculating the disparity shift amount on the basis of the viewpoint position information. The depth information is also used in calculating the disparity shift amount. When the binocular images of all the viewpoints are generated, the image data for 3D-display are generated by compositing the images in the image compositor 13 in step S5. The depth information is also used in calculating the compositing treatment in the image compositor 13. The image compositor 13 stores the image data for 3D-display into a line buffer in step S6. The image compositor 13 serially outputs the image data for 3D-display into the 3D-display 2 in step S6. The image generator 5 serially reads out the image data as the 3D-display 2 stored in the line buffer in step S7.

In the image processor 1, only material image is drawn by the drawing portion 3. On the other hand, the image related to each viewpoint is generated by the image generator 5. Consequently, image processing load can be decreased compared to a case that all the images on each viewpoint are drawn. Further, the data of only the material images are retained in the memory portion 4. On the other hand, only one line of the line buffer in the image generator 5 retains the data of the image data for 3D-display. Further, only the data with respect to the memory portion 4 are retained, and only the data according to one line in the image generator 5 are retained on the image data for 3D display. The frame buffer with less the viewpoints may be prepared in the image processor 1. Therefore, memory consumption can be decreased in a case that the frame buffer for both eyes is necessary to be full number of the viewpoints. Further, only the data read and write between the drawing portion 3 and the memory portion 4, and the image generator 5. Accordingly, transaction of the bus can be decreased as compared to a case that all the image data write and read.

As mentioned above, decreasing the load in drawing processing, the memory consumption, the transaction in the system bus can be decreased in increasing a number of the viewpoint positions corresponding to the 3D-display. Consequently, the method mentioned above has an effect that a load of the hardware constitution can be decreased in the 3D-display corresponding to many viewpoint positions. The image processor 1 can be constituted by slightly changing or adding to a circuit using conventional technology such as a plane composition or the like. Further, the treatment for generating disparity can be restricted to the unit of one line in the display by the construction in which the disparity is generated in restriction of horizontal migration on the image. As a result, assembly cost of the hardware can be improved.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalent are intended to cover such forms or modifications as would fall within the scope and sprit of the inventions.

What is claimed is:

1. An image processor, comprising:
a material image drawing portion drawing a material image, the material image is a material for a 3D display;
a material image memory portion storing data of the material image drawn by the material image drawing portion; and
an image generator generating image data for the 3D display on a basis of the data of the material image read from the material image memory portion, depth information configured to the material image, and viewpoint position information preliminary configured, and outputting the image data to a display portion.

2. The image processor of claim 1, wherein
the image generator includes a disparity generator generating a binocular image of each viewpoint position on a basis of the depth information and the viewpoint position information.

3. The image processor of claim 2, wherein
the disparity generator generates the binocular image having a disparity in a horizontal direction.

4. The image processor of claim 1, wherein
the image generator includes a viewpoint position counter which outputs a count value showing the viewpoint position.

5. The image processor of claim 4, wherein
the disparity generator generates the binocular image to the material image in accordance with each input of the count value.

6. The image processor of claim 2, wherein
the image generator includes an image compositor which composites left eye images, each left eye image corresponds to each material image, and composites right eye images, each right eye image corresponds to each material image, so as to generate the image data for the 3D display.

7. The image processor of claim 6, wherein
a disparity shift amount of the left eye image and the right eye image is calculated corresponding to the depth information data and the viewpoint position information input as the count value.

8. The image processor of claim 7, wherein
the left eye image is generated by shifting to the right direction horizontally to the image material by the disparity shift amount and the right eye image is generated by shifting to the left horizontally to the image material direction by the disparity shift amount.

9. The image processor of claim 8, wherein
the shift is performed by changing correspondences between a standard coordinate and the left eye image, and the standard coordinate and the right eye image.

10. The image processor of claim 5, wherein
a hidden surface removal treatment is used in compositing the image by the image generator.

11. The image processor of claim 5, wherein
an α-blend treatment is used in compositing the image by the image generator.

12. The image processor of claim 1, wherein
the material image memory portion includes a first memory portion and a second memory portion, the material image data is stored in the first memory portion and the depth information is stored in the second memory portion as a data buffer.

13. The image processor of claim 12, wherein
the image generator read the material image data stored in the first memory portion and the depth information data stored in the second memory portion one line by one line to the parallel direction, respectively.

14. The image processor of claim 13, wherein
the binocular image is generated corresponding to the depth information data read from the second memory portion and the count value on a basis of the material image data read from the first memory portion.

15. The image processor of claim 1, wherein
the depth information is configured in the image generator as a characteristic value of each plane.

16. The image processor of claim 1, wherein
the depth information is generated in the disparity generator.
